(19) United States
(12) Patent Application Publication
(10) Pub. No.: US 2014/0136671 A1
(43) Pub. Date: May 15, 2014

(54) DEVICE AND METHOD FOR AGGREGATING SERVICES FOR USE ACROSS NETWORKS USING SEPARATE DATA FORMAT PROTOCOLS

(71) Applicant: GENERAL ELECTRIC COMPANY, Schenectady, NY (US)

(72) Inventors: Jeff Drake, Louisville, KY (US); Myles Caley, La Grange, KY (US); Christopher BAKER, Louisville, KY (US)

(73) Assignee: General Electric Company, Schenectady, NY (US)

(21) Appl. No.: 13/676,253

(22) Filed: Nov. 14, 2012

(51) Int. Cl. G06F 15/173

(52) U.S. Cl. 709/223

(57) ABSTRACT

A device comprises a processor, memory, and executable instructions stored on memory and configured to be executed by the processor. The executable instructions includes executable instruction for receiving a signal comprising a first coded representation representing a service of a remote device, the first coded representation representing the service in a first data protocol of a non-IP network, translating the first coded representation representing the service to a second coded representation representing the service, the second coded representation in a second data protocol using a DNS-based Service Discovery convention that allows a device on an IP network to recognize the availability of the service, and generating a service record with the second coded representation.

### BACKGROUND

The subject matter of the present disclosure relates to devices that support communications between network devices found on different networks that use different data formal protocols.

Use of multiple device networks at a single location or premise is relatively prevalent. For example, homes often utilize one network to provide access for devices to the Internet and one network that allows household devices, e.g., appliances, to communicate among themselves and a centrally located device. One problem with this configuration is that the two networks use different data protocols. The lack of uniformity hinders ready and reliable cross-communication amongst devices that are found on the different networks.

### BRIEF DESCRIPTION OF THE INVENTION

The present disclosure describes, in one embodiment, a device that comprises a processor, memory, and executable instructions stored in memory and configured to be executed by the processor. The executable instructions comprising executable instruction for receiving a signal representing a first coded representation of a service of a remote device, the first coded representation representing the service in a first data protocol of a non-IP network. The executable instruction also comprising executable instruction for translating the first coded representation to a second coded representation of the service, the second coded representation representing the service in a second data protocol using a DNS-based Service Discovery convention that allows a device on an IP network to recognize the availability of the service; and generating a service record with the second coded representation of the service.

The present disclosure also describes, in one embodiment, a system that comprises a first device on a non-IP network configured to communicate using a first data protocol and a second device on an IP network configured to communicate using a second data protocol that is different from the first data protocol. The system also comprises a central node device in communication with the first device on the non-IP network and the second device on the IP network. The central node device comprising a service registry with a service record that associates a first coded representation of the service of the first device with a second coded representation of the service in a second data protocol using a DNS-based Service Discovery convention that allows the second device on the IP network to recognize the availability of the service when communicating with the central node device.

The present disclosure further describes, in one embodiment, a method that comprises, at a device comprising a processor and memory, steps for receiving a signal representing a first coded representation of a service of a remote device in a first data protocol of a non-IP network and for translating the first coded representation of the service to a second coded representation of the service in a second data protocol for use with an IF network using a DNS-based Service Discovery convention that allows a device on an IP network to recognize the availability of the service. The method also comprises steps for generating a service record with the second coded representation of the service.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 depicts a schematic diagram of an exemplary embodiment of a central node device that permits communication of devices across different networks;

FIG. 2 depicts additional details of the central node device of FIG. 1;

FIG. 3 depicts a flow diagram of an exemplary method to permit communication between devices across different networks; and

FIG. 4 depicts a schematic diagram of a high-level wiring schematic of a central node device, e.g., the central node device of FIGS. 1 and 2.

Where applicable like reference characters designate identical or corresponding components and units throughout the several views, which are not to scale unless otherwise indicated.

### DETAILED DESCRIPTION OF THE INVENTION

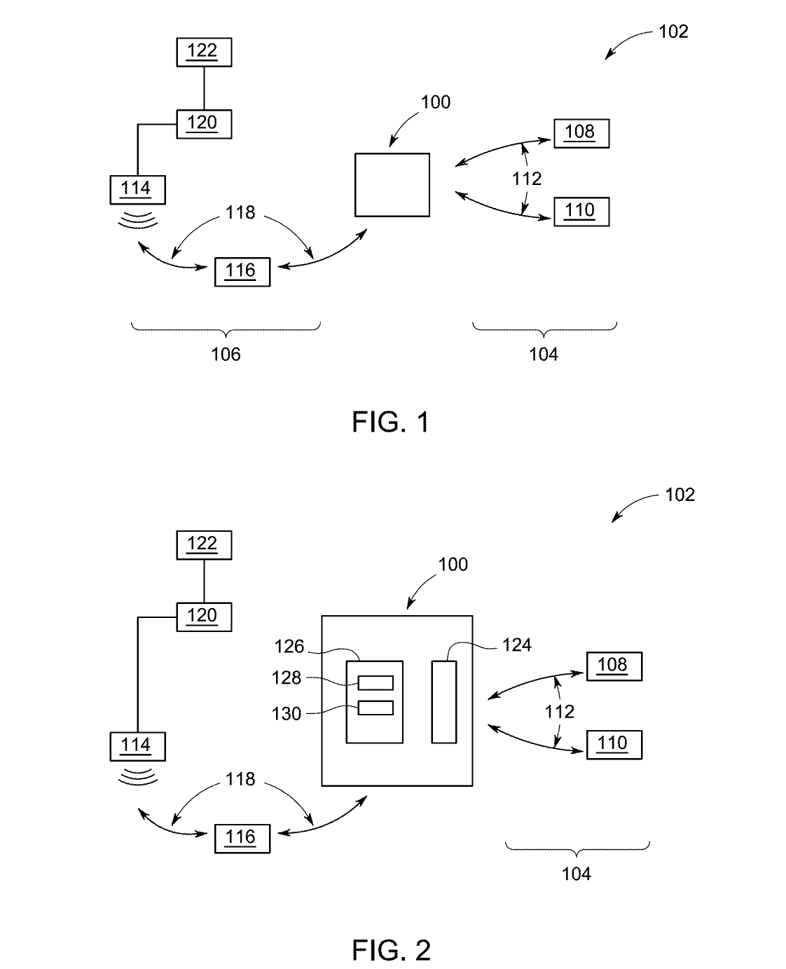

FIG. 1 illustrates an exemplary embodiment of a central node device 100 that can simplify communication between networks and the devices found thereon. Examples of the central node device 100 can bridge communication gaps between networks (and networked devices) that use different data formats and/or communication protocols. This feature alleviates issues that prevent cross-network communication between devices on different networks, e.g., networks that support intra-device communication via internet protocols (“IP networks”) and networks that support intra-device communication via non-internet protocols (“non-IP networks”). As set forth below, for example, the central node device 100 permits devices on IP networks to recognize (alternatively “identify” or “discover”) devices on non-IP networks. Upon discovery, an end user can then utilize the IP networked devices to access the functions and features (also, collectively, “services”) the non-IP networked devices support.

The examples below illustrate one implementation for the central node device 100 that facilitates communication between one or more household devices, which are typically configured for non-IP networks, and computing devices (e.g., computers, smartphones, etc.) found on home IP networks. The resulting communication allows access to the services available for each of the household devices, e.g., via the computing device. This disclosure does, however, contemplate that the central node device 100, as well as other concepts described herein, can apply to other uses that require communication of devices across a plurality of differently-enabled networks.

In one aspect, the central node device 100 deploys Domain Name System (DNS) based Service Discovery conventions to advertise and to make available the services of devices on the non-IP networks to devices on the IP networks. DNS-based Service Discovery defines conventions for naming and organizing resource records in support of service discovery, e.g., by the IP network devices. As used herein, the term “service” refers to any function that is available on the networks to be linked by the central node device. These functions may be associated with one or more devices, e.g., household appliances, light fixtures, among others. This feature of the central node device 100 offers a centralized location for the devices on the IP networks to connect and communicate to locate and/or browse the services that are available on the non-IP networks. For example, in one implementation, an individual can use a tablet to communicate with the central node device 100 to see all of the services available on the non-IP network. These services may include the functions of the household refrigerator (e.g., temperature settings) and light fixtures (e.g., on/off), both of which communicate with the central node device 100 using a protocol that is different from the protocol found on of the IP network.

From a broader perspective, the central node device 100 configured with this centralized service registry eliminates the need for complicated device configurations that might be required for communication between the tablet and each of the non-IP household devices. Rather, communication of the tablet and the non-IP devices occurs via a single connection point, i.e., the central node device 100. The ease of access promotes operation and/or manipulation of the advertised services (e.g., the functions of the refrigerator) using the tablet device. For example, applications and software for the tablet device can provide the end user with a cadre of choices to operate, monitor, and solicit information and data from appliances in the household.

As shown in FIG. 1, the central node device 100 is part of a system 102 with a first network 104 and a second network 106. The first network 104 includes a first remote device 108 and a second remote device 110 that communicate directly with the central node device 100 using a first data protocol 112. Examples of the first data protocol 112 include Zigbee®, Bluetooth®, and like wireless communication protocols. The first remote device 108 and the second remote device 110 can also communicate with each other, either via the first data protocol 112 or other communication protocols. As also shown in FIG. 1, the second network 106 includes a router 114 and a third remote device 116, which communicates with the router 114 and the central node device 100 via a second data protocol 118. The router 114 couples with a modem 120 that connects with an Internet service provider 122 to offer access, e.g., to the Internet. Examples of the second data protocol 118 includes the so-called Internet Protocol (IP), which is commonly used in networks to permit devices to communicate with the Internet.

The system 102 can be found in homes, offices, or other locations (collectively, “premises”) that have and/or incorporate multiple networks (e.g., the first network 104 and the second network 106). For homes, for example, the first network 104 can operate as a home energy management (HEM) network. The central node device 100 helps manage operation of the first remote device 108 and the second remote device 110. HEM networks often also include smart meters to convey information, e.g., about energy usage, to the central node device 100. On the other hand, the second network 106 allows the third remote device 116 to connect with the Internet as well as to communicate with other devices via the router 114. Examples of the second network 106 can operate as a so-called local area network (LAN), wherein a number of different devices can communicate with the Internet service provider 116.

Examples of the central node device 100 provide a central point of communication to exchange data and information between the first remote device 108, the second remote device 110, and the third remote device 116, as well as other devices found on the first network 104 and the second network 106. Devices found on the first network (e.g., the first remote device 108 and the second remote device 110) can include appliances (e.g., refrigerators, stoves, etc.) and/or other devices (e.g., light fixtures, hot water heaters, air conditioners, etc.). Exemplary devices found on the second network 106 (e.g., the third remote device 116) include a wide variety of computing devices, e.g., desktop computers, laptop computers, tablet computers, smartphones, and the like.

The data and information can include code identifying or representing the services that the appliances and devices on the first network 104 can perform. As set forth above, these services may include, for example, simple operations to operate a light on and/or off as well as other operations that dictate more advanced tasks, e.g., to operate a compressor to regulate temperature in a refrigerator. In one embodiment, the central node device 100 allows the third remote device 116 to recognize the availability of and make use of the services for the first remote device 108 and the second remote device 110. While the availability of these services are typically unrecognizable across the first network 104 and the second network 106 because of differences in the communication protocols (e.g., the first data protocol 112 and the second data protocol 118), the central node device 100 can aggregate the services, e.g., of the first remote device 108 and the second remote device 110, and format these services in a manner that the third remote device 116 can recognize and understand. In one embodiment, formatting utilizes DNS-based Service Discovery conventions. This feature of the central node device 100 permits, by way of example, an end user to use the third remote device 116 to manipulate the services of the first remote device 108 and the second remote device 110 simply by communicating with the central node device 100.

FIG. 2 depicts additional details of the central node device 100 to illustrate this aggregation feature. In the example of FIG. 2, the central node device 100 includes an aggregator module 124 and a service registry module 126 that has a plurality of service records (e.g., a first service record 128 and a second service record 130). The first service record 128 and the second service record 130 represent one or more services found on devices of the first network 104, e.g., on the first remote device 108 and the second remote device 110.

The modules facilitate the discovery of services between devices on the first network 104 and the second network 106, which would normally not occur because of the different communication protocols that prevail on the networks of the system 102. For example, the aggregator module 124 generates the service records 128, 130 in response to signals (also, “data packets”) from one or more of the first remote device 108 and the second remote device 110. These data packets may include information about the services found on the respective device, often encoded using the data protocol of the network on which the device is found. The aggregator module 124 can translate code representing the services (e.g., a first coded representation representing a service) encoded in one data protocol (e.g., the first data protocol 112) to a code representing the services (e.g., a second coded representation representing the service) that is recognized by devices that use another data protocol (e.g., the second data protocol 118). In one example, the aggregator module 124 translates a first coded representation representing a service in a first data protocol to a second coded representation representing a service defined in a second data protocol for use with an IP network using a DNS-based Service Discovery convention that allows a device on an IP network to recognize the availability of the service.

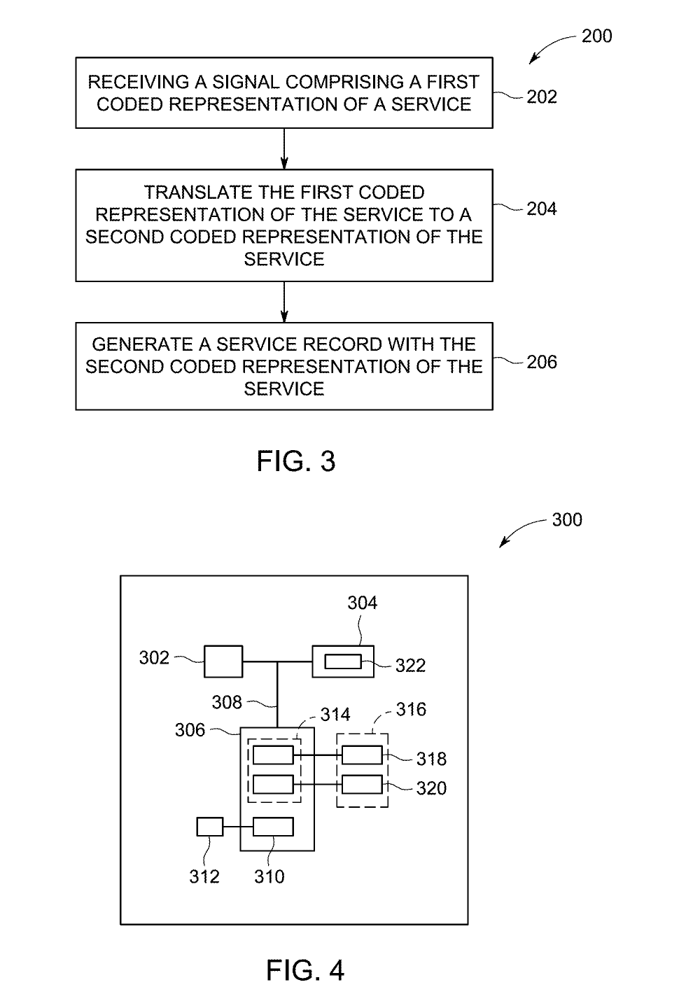

FIG. 3 illustrates a method 200 that permits discovery or recognition of services between networks that use different communication protocols. The method 200 includes one or more steps that can be coded as one or more executable instructions (e.g., hardware, firmware, software, software programs). Embodiments of a central node device (e.g., central node device 100 of FIGS. 1 and 2) utilize one or more modules (e.g., aggregator module 120 of FIG. 2) to execute these executable instructions.

As shown in FIG. 3, the method 200 includes, at step 202, receiving a signal comprising a first coded representation representing a service of a remote device in a first data protocol of a non-IP network. The method 200 also includes, at step 204, translating the first coded representation of the service to a second coded representation of the service in a second data protocol using a DNS-based Service Discovery convention that allows a device on an IP network to recognize the service. The method 200 further includes, at step 206, generating a service record which associates the second coded representation with the service.

The received signal (e.g., at step 202) can come in the form of a data packet that encodes information using a variety of encoding schemes. Exemplary schemes can use numeric, alphabetic, and alphanumeric coding such as binary and ASCII coding. The present disclosure likewise considers more complex encoding, which can provide more secure communication of information if necessary between the central node device and the remote devices and, generally, about the system and networks contemplated herein.

Translating the first coded representation of a service to a second coded representation of a service (e.g., at step 204) associates the services represented by a code of one data protocol (e.g., first data protocol 112 of FIGS. 1 and 2) with the representation of the services by a code of another data protocol (e.g., second data protocol 118 of FIGS. 1 and 2). This feature enables devices to recognize the various services that may be available on corresponding networks, which would normally not occur because of differences in data protocols that are used on the networks. This step may access a look-up table (or database) that has entries which identify or associate a specific service represented in more than one data protocol (e.g., first data protocol 112 and second data protocol 118 of FIGS. 1 and 2).

An example of one configuration of the look-up table is found in Table 1 below.

TABLE 1

| | First Data Protocol | Second Data Protocol |
|---|---|---|
| Device | (DP1) | (DP2) |
| Remote Device 1 | R1 Service 1 DP1 | R1 Service 1 DP2 |
| | R1 Service 2 DP1 | R1 Service 2 DP2 |
| Remote Device 2 | R2 Service 1 DP1 | R2 Service 1 DP2 |

As shown in Table 1, the look-up table includes information for two remote devices (e.g., remote device 108 and remote device 110 of FIGS. 1 and 2). The entries in the look-up table represent the services for each of the remote devices in two different data protocols. In one example, the method 200 queries the look-up table to find the entry in the table that corresponds to the service the received signal encodes using the first data protocol (DP1). The method 200 can thereafter identify the service and/or definition of the services using the second data protocol (DP2). In one example, the entries for the second data protocol use a DNS-based Service Discovery convention that allows a device on an IP network to recognize the availability of the service.

Generating the service record (e.g., at step 206) can retain that association between the coded representation of the services that occurs during the translating step. Data retention can occur by way of saving the second coded representation of the service, or an indicator thereof, to a repository (e.g., memory). The data can be tabulated to account for the addition, replacement, and/or removal of new devices into the networks (e.g., first network 104 and second network 106 of FIGS. 1 and 2).

In one embodiment, the method 200 can further include steps to identify a service from the received signal. These steps may associate information from the received signal with other information that relates to the service. This information may be found in a look-up table and/or other database that establishes the relationship between the received signal, the services available for the remote device that generates the received signal, and/or the first coded representation of a service that the received signal actually encodes. In one example, the look-up table and/or database identifies the services based on type of remote device. Examples of the method 200 can also include steps to parse, filter, decode, and manipulate the information to extract the relevant information necessary to identify the services encoded therein.

The method 200 may also include steps to generate an output that encodes the service record. The central node device (e.g., central node device 100 of FIGS. 1 and 2) may transmit this output in response to queries by devices on the networks. In one implementation that finds use with IP protocol networks and non-IP protocol networks, when an IP protocol device queries the central node device, the output will provide to the IP protocol device service records for one or more of non-IP protocol devices. Thus, the IP protocol device will recognize all of the services of the all of the remote devices on the non-IP protocol network on one device (e.g., central node device central node device 100 of FIGS. 1 and 2).

In view of the foregoing, execution of one or more of the steps in method 200 by the central node device can generate a plurality of service records for each of the devices found in the networks and, in one particular example, the devices found on the non-IP network. Access to the resulting listing of service records permits a device on the IP network to recognize the services for one or more device on the non-IP network notwithstanding the differences in data protocols that often occurs between the non-IP network and the IP network.

FIG. 4 depicts a schematic diagram that presents, at a high level, a wiring schematic for a central node device 300 that permits communication between devices on different networks. The central node device 300 includes a processor 302, memory 304, and control circuitry 306. Busses 308 couple the components of the central node device 300 together to permit the exchange of signals, data, and information from one component of the central node device 300 to another. In one example, the control circuitry 306 includes port circuitry 310 which couples with a data port 312 (e.g., an Ethernet port, a USB port, etc.). The control circuitry 306 also includes radio circuitry 314 that couples with one or more radios 316, e.g., devices that operates in accordance with one or more of the wireless protocols contemplated herein. The radios 316 can include a first radio 318, e.g., a ZigBee® radio, and a second radio 320, e.g., a WiFi radio. As also shown in FIG. 4, memory 304 can include one or more software programs 322 in the form of software and/or firmware, each of which can comprise one or more executable instructions configured to be executed by the processor 302.

This configuration of components can dictate operation of the central node device 300 to generate the service records. For example, the central control node 300 can receive signals through the data port 312 and/or the radios 316. These signals may convey information about the various services that are available on the devices of the networks to which the central node device 300 connects.

Examples of the central node device 300 and its constructive components can communicate amongst themselves and/or with other circuits (and/or devices), which execute high-level logic functions, algorithms, as well as executable instructions (e.g., firmware instructions, software instructions, software programs, etc.). Circuits of this type include discrete elements such as resistors, transistors, diodes, switches, and capacitors. Examples of the processor 302 include microprocessors and other logic devices such as field programmable gate arrays (“FPGAs”) and application specific integrated circuits (“ASICs”). Although all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

In one embodiment, the processor 302 is a central processing unit (CPU) such as an ASIC and/or an FPGA that is configured to instruct and/or control operation of the central control node 300. This processor can also include state machine circuitry or other suitable components capable of controlling operation of the components as described herein. The memory 304 includes volatile and non-volatile memory and can store executable instructions in the form of and/or including software (or firmware) instructions and configuration settings. Each of the control circuitry 306 can embody stand-alone devices such as solid-state devices. Examples of these devices can mount to substrates such as printed-circuit boards and semiconductors, which can accommodate various components including the processor 302, the memory 304, and other related circuitry to facilitate operation of the central control node 300.

However, although FIG. 4 shows the processor 302, the memory 304, and the components of the control circuitry 306 as discrete circuitry and combinations of discrete components, this need not be the case. For example, one or more of these components can comprise a single integrated circuit (IC) or other component. As another example, the processor 302 can include internal program memory such as RAM and/or ROM. Similarly, any one or more of functions of these components can be distributed across additional components (e.g., multiple processors or other components).

Moreover, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In light of the discussion above, embodiments of the proposed system and method facilities recognition of the availability of devices services across networks that use different communication protocols. A technical effect of the proposed configurations is to improve communication of devices found, for example, an IP network and on a non-IP network.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device comprising:
a processor;
memory; and
executable instructions stored in the memory and configured to be executed by the processor, the executable instructions comprising executable instruction for:
receiving a signal representing a first coded representation of a service of a remote device, the first coded representation representing the service in a first data protocol of a non-IP network;
translating the first coded representation to a second coded representation of the service, the second coded representation representing the service in a second data protocol using a DNS-based Service Discovery convention that allows a device on an IP network to recognize the availability of the service; and
generating a service record with the second coded representation of the service.

2. The device of claim 1, further comprising executable instructions for selecting the second coded representation of the service from a look-up table that comprises one or more entries that associate the first coded representation of the service using the first data protocol with the second coded representation of the service using the second data protocol.

3. The device of claim 1, further comprising executable instructions for storing the service record in a database.

4. The device of claim 1, further comprising executable instructions for generating an output that encodes the service record.

5. The device of claim 4, wherein the output comprises a message that includes the first coded representation of the service and the second coded representation of the services.

6. The device of claim 1, further comprising executable instructions for generating a user interface that displays the service record.

7. The device of claim 1, wherein the service defines a function of a household appliance.

8. The device of claim 1, wherein the first data protocol comprises Bluetooth protocol format.

9. The device of claim 1, wherein the first data protocol comprises a Zigbee protocol format.

10. The device of claim 1, wherein the first data protocol comprises a wireless personal area network (WPAN) protocol.

11. A system comprising:
a first device on a non-IP network configured to communicate using a first data protocol;
a second device on a IP network configured to communicate using a second data protocol that is different from the first data protocol; and
a central node device in communication with the first device on the non-IP network and the second device on the IP network, the central node device comprising a service registry with a service record that associates a first coded representation of the service of the first device with a second coded representation of the service in a second data protocol using a DNS-based Service Discovery convention that allows the second device on the IP network to recognize the availability of the service when communicating with the central node device.

12. The system of claim 11, wherein the first device comprises a household appliance.

13. The system of claim 11, wherein the first data protocol comprises Zigbee.

14. The system of claim 11, wherein the central node device comprises one or more executable instructions to translate the first coded representation of the service in the first data protocol to the second coded representation of the service in the second data protocol using the DNS-based Service Discovery convention.

15. The system of claim 14, wherein the central node device comprises one or more executable instructions to access a look-up table with entries that associate the first coded representation of the service with the second coded representation of the service.

16. A method comprising:
at a device comprising a processor and memory:
receiving a signal representing a first coded representation of a service of a remote device in a first data protocol of a non-IP network;
translating the first coded representation of the service to a second coded representation of the service in a second data protocol for use with an IP network using a DNS-based Service Discovery convention that allows a device on an IP network to recognize the availability of the service; and
generating a service record with the second coded representation of the service.

17. The method of claim 16, further comprising generating an output that encodes the service record.

18. The method of claim 16, further comprising storing the service record in a database.

19. The method of claim 16, further comprising identifying the service represented by the signal based on a type for the remote device.

20. The method of claim 16, further comprising selecting the second coded representation of the service from a look-up table that comprises one or more entries that associate the first coded representation of the service using the first data protocol with the second coded representation of the service using the second data protocol.
